(19) United States
(12) Patent Application Publication
(10) Pub. No.: US 2026/0170242 A1
(43) Pub. Date: Jun. 18, 2026

(54) METHOD AND APPARATUS WITH DATA DESCRIPTION

(71) Applicant: Samsung Electronics Co., Ltd., Suwon-si (KR)

(72) Inventors: Seongeun KIM, Suwon-si (KR); Seungin PARK, Suwon-si (KR); Kyunhyun SHIM, Suwon-si (KR); Ilwi YUN, Suwon-si (KR); Dongwook LEE, Suwon-si (KR); Wonjun CHOI, Suwon-si (KR); Sunjun HWANG, Suwon-si (KR)

(73) Assignee: Samsung Electronics Co., Ltd., Suwon-si (KR)

(21) Appl. No.: 19/246,901

(22) Filed: Jun. 24, 2025

(30) Foreign Application Priority Data
Dec. 12, 2024 (KR) 10-2024-0185093

(51) Int. Cl. G06F 40/279; G06F 16/353

(52) U.S. Cl. CPC G06F 40/279; G06F 16/353

(57) ABSTRACT

Provided is a method and apparatus for describing data using a language model. The method includes executing a language model based on non-text-based input data to generate a first key for describing the input data in a text-based key-value format, executing a first expert model, selected from among expert models, based on the first key to generate a first value corresponding to the first key, executing the language model based on the first key and the first value to generate a second key, executing a second expert model, selected from among the expert models, based on the second key to generate a second value corresponding to the second key, and generating output data in the text-based key-value format by executing the language model and the expert models based on a first key-value pair comprising the first key and the first value, and a second key-value pair comprising the second key and the second value.

### CROSS-REFERENCE TO RELATED APPLICATIONS

This application claims the benefit under 35 USC § 119 (a) of Korean Patent Application No. 10-2024-0185093, filed on Dec. 12, 2024, in the Korean Intellectual Property Office, the entire disclosure of which is incorporated herein by reference for all purposes.

### BACKGROUND

### 1. Field

The examples of the disclosure relate to a method and apparatus with data description using a language model.

### 2. Description of Related Art

The automation of recognition processes has been achieved, for example, via neural network models implemented as specialized computational structures, such as processors. After considerable training, these models may provide computationally intuitive mappings between input and output patterns. This mapping capability may be considered as a learning ability of a neural network. Moreover, due to this specialized training, the neural network may acquire a generalization capability to generate relatively accurate outputs for an untrained input pattern, for example.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes executing a language model based on non-text-based input data to generate a first key for describing the input data in a text-based key-value format; executing a first expert model, selected from among expert models, based on the first key to generate a first value corresponding to the first key; executing the language model based on the first key and the first value to generate a second key; executing a second expert model, selected from among the expert models, based on the second key to generate a second value corresponding to the second key; and generating output data in the text-based key-value format by executing the language model and the first and second expert models based on a first key-value pair comprising the first key and the first value, and a second key-value pair comprising the second key and the second value.

The generating of the first value may include selecting the first expert model having a highest suitability for processing the first key from among the expert models; and executing the selected first expert model based on the input data to generate the first value.

The selecting of the first expert model may include selecting the first expert model matched to the first key from among the expert models matched to a plurality of keys.

The selecting of the first expert model may include executing a selection model based on the first key to generate suitability scores indicating a suitability of each of the expert models for processing the first key; and selecting the first expert model based on the suitability scores.

The generating of the first value may include, in response to a determination that the language model has a higher suitability than the expert models for processing the first key, generating the first value using the language model in place of the expert models.

The generating of the output data may include generating one or more key-value pairs using the language model and the expert models until a number of executions of the language model reaches a threshold; and generating one or more additional key-value pairs using the language model without the expert models in response to the number of executions of the language model exceeding the threshold.

The first key may represent a high level class of an object in the input data, and the first expert model may serve as a high level classifier.

The second key may represent a low level class within the high level class, and the second expert model may serve as a low level classifier.

In one general aspect, a method of describing non-text-based input data in a text-based key-value format includes generating early key-value pairs of output data by alternately executing a language model and expert models until a number of executions of the language model reaches a threshold; and generating late key-value pairs of output data, subsequent to the early key-value pairs, by executing the language model without the expert models in response to the number of executions of the language model exceeding the threshold.

The generating of the early key-value pairs may include executing the language model based on the input data to generate a first key of the early key-value pairs; executing a first expert model, selected from among the expert models, based on the first key to generate a first value corresponding to the first key; executing the language model based on the first key and the first value to generate a second key; and executing a second expert model, selected from among the expert models, based on the second key to generate a second value corresponding to the second key.

The generating of the first value may include selecting the first expert model having a highest suitability for processing the first key from among the expert models; and executing the first expert model based on the input data to generate the first value.

The selecting of the first expert model may include selecting the first expert model matched to the first key from among the expert models matched to a plurality of keys.

The selecting of the first expert model may include executing a selection model based on the first key to generate suitability scores indicating a suitability of each of the expert models for processing the first key; and selecting the first expert model based on the suitability scores.

The generating of the first value may include, in response to a determination that the language model has a higher suitability than the expert models for processing the first key, generating the first value using the language model in place of the expert models.

In one general aspect, an electronic device includes one or more processors; and a memory storing code, wherein the code, when executed by the one or more processors, configures the one or more processors to, execute a language model based on non-text-based input data to generate a first key for describing the input data in a text-based key-value format, execute a first expert model, selected from among expert models, based on the first key to generate a first value corresponding to the first key, execute the language model based on the first key and the first value to generate a second key, execute a second expert model, selected from among the expert models, based on the second key to generate a second value corresponding to the second key, and generate output data in the text-based key-value format by executing the language model and the expert models based on a first key-value pair comprising the first key and the first value, and a second key-value pair comprising the second key and the second value.

The one or more processors may be further configured to select the first expert model having a highest suitability for processing the first key from among the expert models; and execute the first expert model based on the input data to generate the first value.

The one or more processors may be further configured to select the first expert model matched to the first key from among the expert models matched to a plurality of keys.

The one or more processors may be further configured to execute a selection model based on the first key to generate suitability scores for the expert models, and select the first expert model based on the suitability scores.

The one or more processors may be further configured to, in response to the language model having a higher suitability than the expert models for processing the first key, generate the first value using the language model in place of the expert models.

The one or more processors may be further configured to generate one or more key-value pairs using the language model and the expert models until a number of executions of the language model reaches a threshold, and generate one or more additional key-value pairs using the language model without the expert models in response to the number of executions of the language model exceeding the threshold.

Other features and aspects will be apparent from the following detailed description, the drawings, and the claims.

### BRIEF DESCRIPTION OF THE DRAWINGS

FIG. 1 illustrates an example configuration and operation of a data description model according to one or more embodiments.

FIG. 2 illustrates an example operation of generating output data based on the next token prediction of a language model according to one or more embodiments.

FIG. 3 illustrates an example operation of generating values of the output data using expert models according to one or more embodiments.

FIG. 4 illustrates an example selection operation using a selection model according to one or more embodiments.

FIGS. 5A and 5B illustrate respective example process of generating output data according to one or more embodiments.

FIG. 6 is a flowchart illustrating an example method of describing data according to one or more embodiments.

FIG. 7 is a flowchart illustrating another example method of describing data according to one or more embodiments.

FIG. 8 illustrates an example configuration of an electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

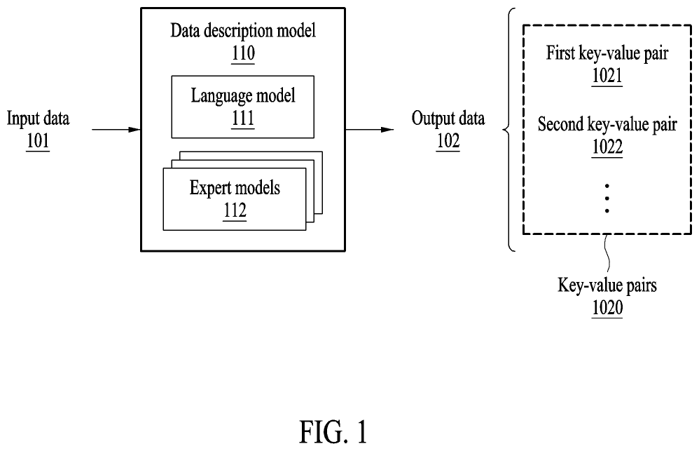

FIG. 1 illustrates an example configuration and operation of a data description model according to one or more embodiments. Referring to FIG. 1, a data description model 110 may include a language model 111 and one or more expert models 112. The data description model 110 may be configured to generate, based on non-text-based input data 101, output data 102 including one or more key-value pairs 1020 describing various attributes of the input data 101 in a text-based format.

The language model 111 and the expert models 112 may each be implemented as a machine learning-based artificial intelligence (AI) model. In one or more embodiments, the language model 111 and the expert models 112 may each be a deep learning-based neural network model. The language model 111 may be various types of AI models for natural language processing, such as a large language model (LLM) and a multi-modal language model (MMLM), but is not limited thereto.

The expert models 112 may be AI models specialized for a target task. For example, the expert models 112 may be configured to perform image processing tasks (e.g., object classification, object identification, object recognition, object authentication, and the like).

The electronic device may use the language model 111 and the expert models 112 to generate the output data 102, which describes the non-text-based input data 101 in a text-based key-value format. For example, the input data 101 may include various types of non-text data, such as image data and sound data. For illustrative purposes, an example is described herein in which the input data 101 comprises image data; however, the disclosure is not limited thereto. Additionally, a text command may be input to the data description model 110 along with the input data 101. The text command may include a command generated to describe the input data 101 in a text-based key-value format.

Describing non-text data in a text-based format may be referred to as text grounding. When an AI model processes non-text data, such as image data, expressing the resulting output in text-based data in place of non-text-based feature vectors may enhance the interpretability of the AI model's operations. Additionally, improved interpretability may facilitate the analysis, debugging, and development of the AI model.

In one or more embodiments, the text grounding may be performed using a text-based key-value format. The text-based key-value format may represent the input data 101 using a set of the key-value pairs 1020, where each pair includes a text key and a corresponding text value. A key may be a question to describe the input data 101, and the corresponding value may be an answer to the question. For example, the key may be an “image type” of the input data 101, and the value may be “food”. The input data 101 may be described based on the key-value pairs 1020. For example, the key-value pairs 1020 may include a first key-value pair 1021, a second key-value pair 1022, and additional pairs as needed. The output data 102 may include N key-value pairs 1020, providing a concise textual representation of the output data 102.

The text-based key-value format may include various delimiters and punctuation marks (e.g., “{”, “}”, “[”, “]”, “:”, “,”, etc.) to structure the data. The text-based key-value format may correspond to a dictionary-style format, such as JavaScript Object Notation (JSON). For example, Table 1 below illustrates an example output generated by the language model 111 when processing an image of a cat, formatted in a dictionary style.

TABLE 1
{
“target object”: {
“type”: “cat”,
“breed”: “siamese”,
“color”: “face, ears, paws, tail are dark and the body is brown and cream
colored”,
“eyes”: “blue”,
“posture”: “the cat is laying on the bed”
},
“background”: {
“material”: “wood”,
“color”: “light wood color”,
“structure”: “a wooden box or shelf made of smooth, light-colored wood
panels”
},
“other objects”: [
{
“type”: “vegetable”,
“color”: “green and white”,
“position”: “leaning next to the cat”,
“description”: “looks like the stem of a vegetable, possibly bok choy or a
similar vegetable”
},
{
“type”: “cat bed”,
“color”: “white dots on gray background”,
“position”: “under the cat”
}
]
}
}

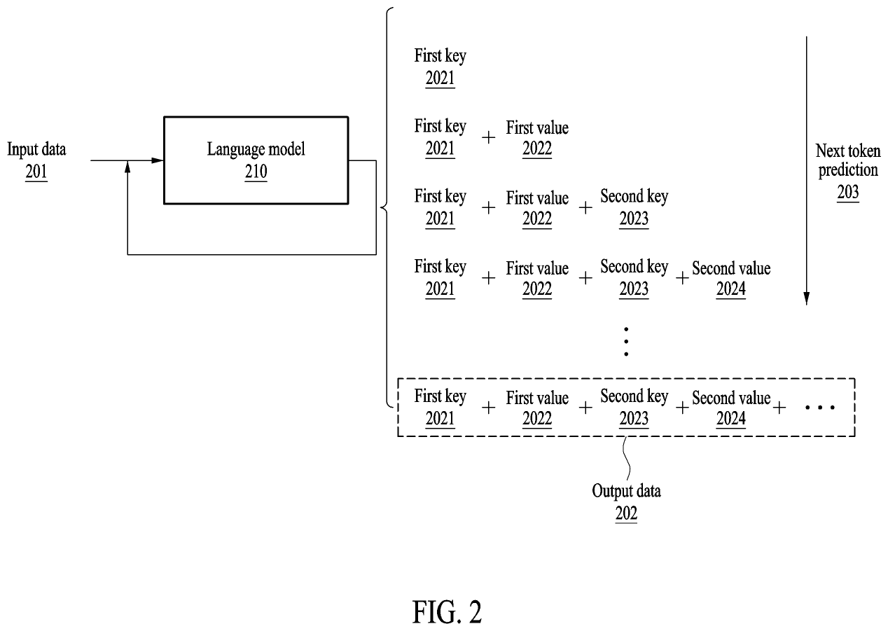

FIG. 2 illustrates an example operation of generating output data based on a next token prediction by a language model according to one or more embodiments. Referring to FIG. 2, a language model 210 may generate output data 202 based on input data 201. The language model 210 may execute a next token prediction 203 to iteratively generate the output data 202.

For example, the language model 210 may predict a first key 2021 based on the input data 201, then predict a first value 2022 based on the input data 201 and the first key 2021 The language model 210 may then predict a second key 2023 based on the input data 201, the first key 2021, and the first value 2022, and predict a second value 2024 based on the input data 201, the first key 2021, the first value 2022, and the second key 2023. Accordingly, the output data 202 may include key-value pairs (e.g., the first key 2021 and the first value 2022; the second key 2023 and the second value 2024) generated through this sequential next token prediction 203.

Because the next token prediction 203 relies on prior tokens, an error in a previously predicted token may propagate and result in subsequent errors in the next token. In one or more embodiments, expert models may be used to suppress such errors. The language model 111, which is typically specialized for natural language processing, may have limited accuracy when processing the non-text-based input data 201. In such cases, expert models specifically designed for particular tasks (e.g., object classification for image data) may be employed. For example, when object classification is required, an object classifier may be used as an expert model to reduce prediction errors in place of the language model.

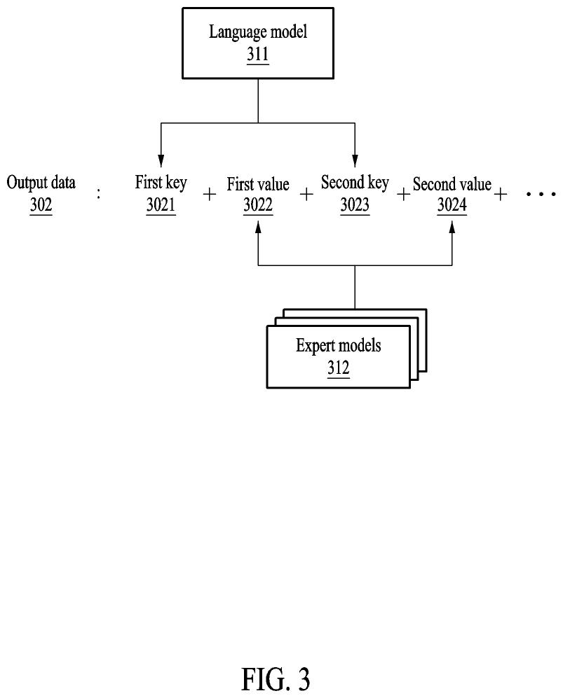

FIG. 3 illustrates an example operation of generating values of output data using expert models. Referring to FIG. 3, an electronic device may execute a language model 311 based on non-text-based input data to generate a first key 3021 representing a descriptor of the input data in a text-based key-value format. The electronic device may then execute a first expert model, selected from among expert models 312, based on the first key 3021 to generate a first value 3022 corresponding to the first key 3021. The expert model may be selected based on its suitability for processing the key. For example, the electronic device may select the first expert model having the highest suitability for processing the first key 3021 among the expert models 312 based on the first key 3021 and execute the first expert model based on the input data to generate the first value 3022. When the language model 311 is determined to have a higher suitability than the expert models 312 for processing the first key 3021, the electronic device may use the language model 311 to generate the first value 3022 in place of the expert models 312.

The electronic device may continue to perform the next token prediction using the language model 311. The electronic device may execute the language model 311 based on the first key 3012 and the first value 3022 to generate/predict a second key 3023. The electronic device may then select and execute a second expert model from the expert models 312 based on the second key 3023 to generate a corresponding second value 3024. The electronic device may select the second expert model having the highest suitability for processing the second key 3023 among the expert models 312 based on the second key 3023 and execute the second expert model based on the input data to generate the second value 3024. When the language model 311 has a higher suitability than the expert models 312 for processing the second key 3023, the electronic device may generate the second value 3024 using the language model 311 in place of the expert models 312.

The electronic device may iteratively perform the next token prediction using the language model 311 to predict subsequent keys based on previously generated key-value pairs. The electronic device may execute the language model 311 based on the first key 3021, the first value 3022, the second key 3023, and the second value 3024 to generate the next keys, and generate the corresponding values of the next keys using the expert models 312 (or the language model 311, if more suitable). The language model 311 and the expert models 312 may be alternately used, depending on suitability for a given task.

The electronic device may execute the language model 311 and the expert models 312 based on previously generated key-value pairs (e.g., first key 3021 and first value 3022, second key 3023 and second value 3024) to generate the output data 302. The output data 302 may include a set of key-value pairs formatted in a text-based representation.

When a token error occurs in an initial stage of the iterative prediction process of the language model 311, the token error may propagate and cause a fatal error in the final output data 302. To mitigate this situation, the expert models 312 may be used during an initial execution phase to suppress early token errors. For example, the electronic device may employ the language model 311 in combination with the expert models 312 to generate a key-value pair of the key-value pairs until a predetermined threshold number of executions of the language model 311 is reached. The key-value pair generated in this initial phase may be referred to as an early key-value pair. When the number of executions of the language model exceeds the threshold, the electronic device may continue to generate a key-value pair of the key-value pairs using the language model 311 without the expert models 312. The key-value pair generated after the threshold is exceeded may be referred to as a late key-value pair. For example, when the threshold is set to “10”, the expert models 312 may be used to generate values for the first through 10th key-value pairs, while the language model 311 alone may be used to generate values starting from the 11th key-value pair.

An operation of selecting an appropriate expert model for each key from the expert models 312 may be implemented in various ways. In one or more embodiments, each of the expert models 312 may be associated with or matched to one or more keys (e.g., the first key 3021, the second key 3023, etc.). A first expert model matched to the first key 3021 may be used to determine the first value 3022, and a second expert model matched to the second key 3023 may be used to determine the second value 3024. The expert models 312 may be pre-matched to the plurality of keys based on the characteristics of the expert models 312, respectively. For example, a first expert model having the highest suitability for processing the first key 3021 may be matched to the first key 3021, and a second expert model having the highest suitability for processing the second key 3023 may be matched to the second key 3023.

In one example, a selection model may be used to perform expert model selection. The electronic device may execute the selection model based on a key (e.g., the first key 3021) to generate suitability scores indicating the suitability of the expert models 312 for processing the corresponding key (e.g., the first key 3021) and may perform a selection operation on the expert models 312 based on the suitability scores. For example, when the first expert model has the highest suitability score for processing the first key 3021, the electronic device may select the first expert model among the expert models 312.

The selection model may be implemented as a machine learning-based AI model, such as a deep learning-based neural network model. The selection model may be pre-trained to generate suitability scores for each of the expert models 312 for processing a corresponding key (e.g., the first key 3021) based on a given input, which may include input data and/or a key (e.g., the first key 3021).

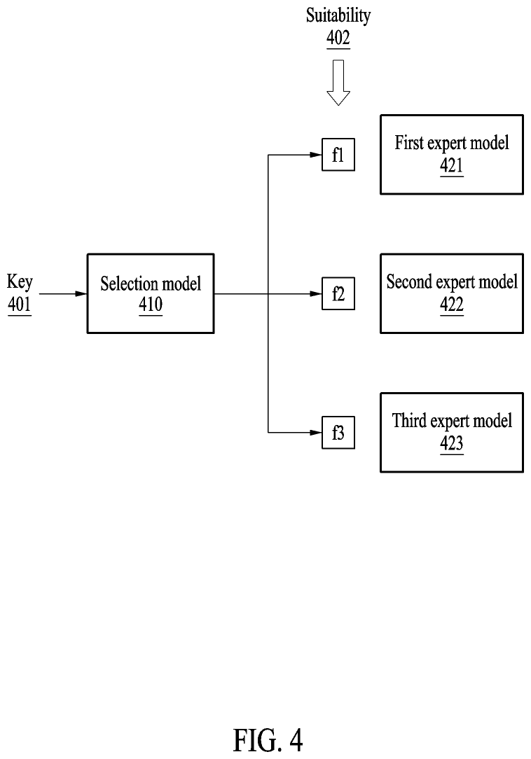

FIG. 4 illustrates an example selection operation using a selection model according to one or more embodiments. Referring to FIG. 4, a selection model 410 may be executed based on a key 401. The selection model 410 may generate suitability scores f1 to f3 indicating a suitability 402 of respective first to third expert models 421 to 423 for processing the key 401. One of the first to third expert models 421 to 423 having the highest suitability score may be selected. For example, when the suitability score f1 is the highest among the scores, the first expert model 421 may be selected.

Input data may be additionally provided to the selection model 410. In this case, the selection model 410 may be executed based on both the input data and the key 401 and may generate the suitability scores f1 to f3 indicating/representing the suitability 402 of the first to third expert models 421 to 423 for processing the key 401.

In one example, when a language model is determined to have a higher suitability than the first to third expert models 421 to 423 for processing a key, a value corresponding to the key may be generated using the language model in place of using the first to third expert models 421 to 423. When the suitability scores f1 to f3 are all below a predetermined expert threshold, a language model may be used in place of the first to third expert models 421 to 423.

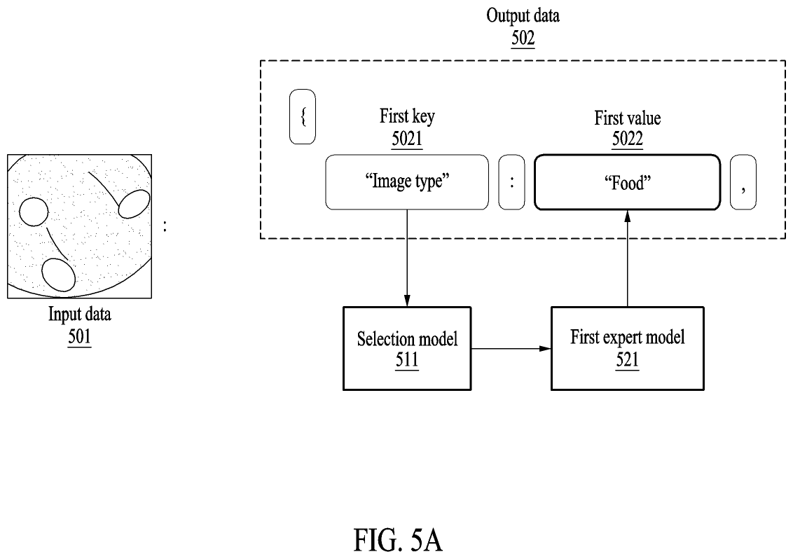

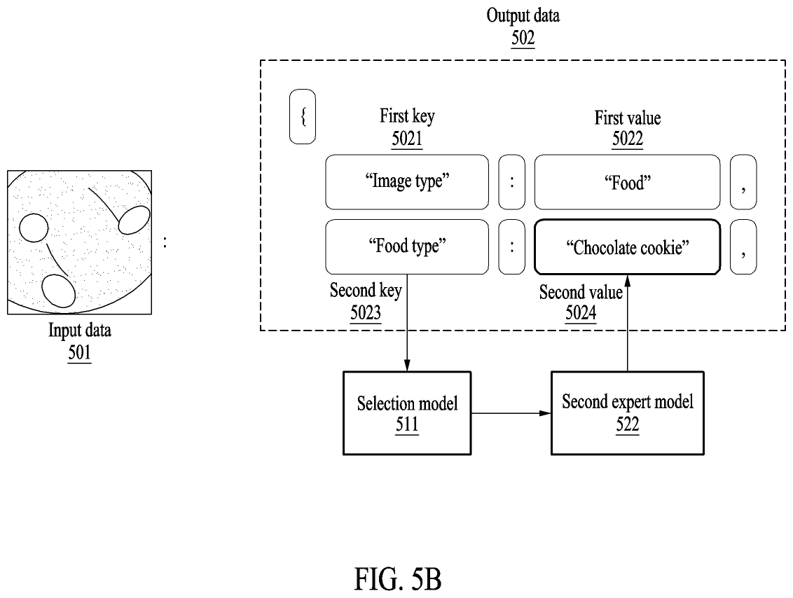

FIGS. 5A and 5B illustrate respective example process of generating output data according to one or more embodiments. Referring to FIG. 5A, a language model may generate a first key 5021 based on input data 501. A selection model 511 may select, based on the first key 5021, a first expert model 521 that is suitable for processing the first key 5021. The first expert model 521 may then generate a first value 5022 based on input data 501. Referring to FIG. 5B, a language model may generate a second key 5023 based on the first key 5021 and the first value 5022. The selection model 511 may select, based on the second key 5023, a second expert model 522 that is suitable for processing the second key 5023. The second expert model 522 may generate a second value 5024 based on the input data 501. The language model and expert models may iteratively perform such operations shown in FIGS. 5A and 5B to generate key-value pairs of output data 502.

In one example, the input data 501 may comprise an image of a chocolate cookie. The language model may generate the first key 5021, such as “image type,” based on the input data 501. The selection model 511 may select the first expert model 521, which is most suitable for classifying the “image type.” The first expert model 521 may identify the “image type” of the input data 501 as “food” and generate “food” as the first value 5022. Subsequently, the language model may generate a the second key 5023, such as “food type,” based on the input data 501, the first key 5021, and the first value 5022. The selection model 511 may select the second expert model 522, which is most suitable for classifying the “food type.” The second expert model 522 may identify the “food type” of the input data 501 as “chocolate cookie” and generate “chocolate cookie” as the second value 5024. Additional keys, such as “appearance,” “color,” “texture,” “size,” or “toppings,” corresponding values such as “pale golden with prominent chocolate chips,” “smooth top, slightly brittle,” “standard cookie size,” or “chocolate chips,” may be generated.

The first key 5021 may represent a high level class of an object included in the input data 501, and the first expert model 521 may serve as a high level classifier. The second key 5023 may represent a low level class within the high level class, and the second expert model 522 may serve as a low level classifier. For example, a high level class may refer to a rough category such as a “dog,” “cat,” “bird,” “food,” or “car,” while a low level class may refer to a specific breed of a dog, cat, or bird, a specific type of food, or a specific type or model of a car.

In one or more embodiments, expert models may be applied to semiconductor image analysis. For example, the first expert model 521 may be a semiconductor type classifier, and the second expert model 522 may be a semiconductor defect detector. The first expert model 521 may determine the type of semiconductor depicted in the input data 501. Based on this determination, the language model may generate a key for determining whether there is a defect. The second expert model 522, which is specialized to detect a defect in the determined semiconductor type, may generate the second value 5024 corresponding to the defect. In such a configuration, the first value 5022 representing a semiconductor type may be generated by the first expert model 521, and the second value 5024 representing the presence or absence of a defect may be generated by the second expert model 522.

Each expert model may be specialized for a particular domain or task. For example, certain expert models may be configured for image processing tasks (e.g., object classification, object identification, object recognition, object authentication, and the like). A known model, such as an object classifier, may be used as an expert model. Each expert model may demonstrate superior performance compared to a language model when executing the specialized task for which it was designed.

In one or more embodiments, errors may occur when relying solely on the language model. For example, due to the arrangement of the chocolate chips in the input data 501, the language model may erroneously recognize the object in the input data 501 as resembling an animal's face. This misclassification may result in incorrect output data 502, such as “animal” being generated as the first value 5022, “breed” being generated as the second key 5023, and “chihuahua” being generated as the second value 5024. Because the language model performs next token prediction, such errors may propagate through subsequent tokens. As a result, keys such as “attribute,” “style,” “fur,” “color,” “eyes,” and values such as “close-up image with focus on face,” “short and soft,” “light brown or tan,” “dark color, large and round shape,” may be incorrectly generated. These errors may be mitigated or suppressed by using validated expert models.

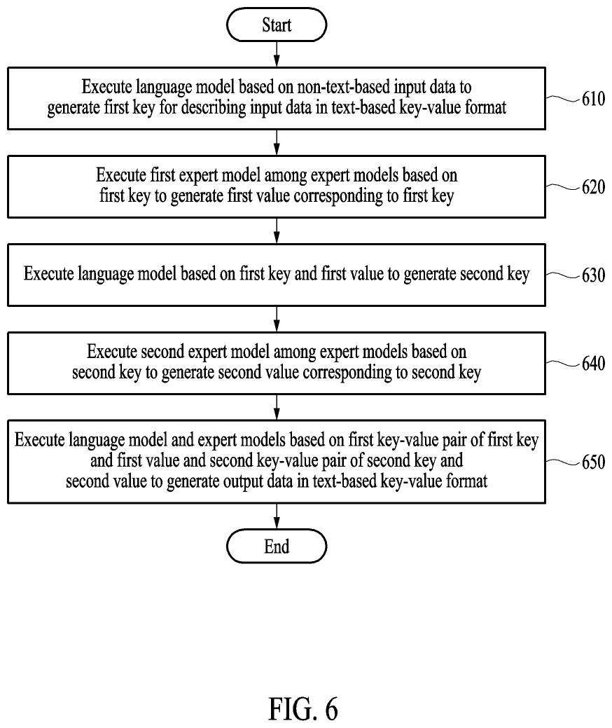

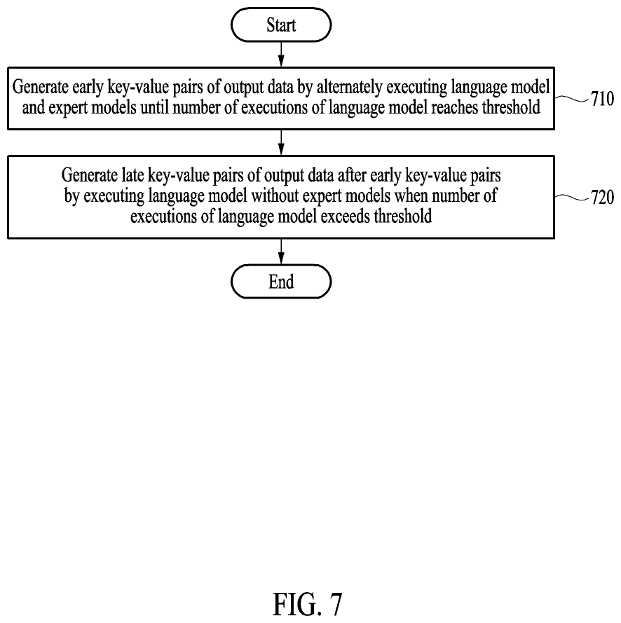

FIGS. 6 and 7 are flowcharts illustrating example methods of describing data according to one or more embodiments. Referring to FIG. 6, in operation 610, an electronic device may execute a language model based on non-text-based input data to generate a first key for describing the input data in a text-based key-value format. In operation 620, the electronic device may execute a first expert model, selected from among a plurality of expert models, based on the first key to generate a corresponding first value. In operation 630, the electronic device may execute the language model based on the first key and the first value to generate a second key. In operation 640, the electronic device may execute a second expert model, selected from among the expert models, based on the second key to generate a corresponding second value. In operation 650, the electronic device may execute the language model and the expert models based on a first key-value pair of the first key and the first value and a second key-value pair of the second key and the second value to generate output data in the text-based key-value format including key-value pairs including the first key-value pair and the second key-value pair.

Operation 620 may include selecting the first expert model having the highest suitability for processing the first key, from among the expert models, and executing the selected first expert model based on the input data to generate the first value. The selection process may include selecting the first expert model matched to the first key among the expert models matched to a plurality of keys. The selecting of the first expert model may include executing a selection model, based on the first key, to generate suitability scores indicating a suitability of the expert models for processing the first key, and selecting the first expert model among the expert models based on the suitability scores. The expert model with the highest suitability score may then be selected.

Operation 620 may include, generating the first value using the language model in place of the expert models when the language model exhibits a higher suitability than the expert models for processing the first key, based on the corresponding suitability scores.

Operation 650 may include generating a key-value pair of the key-value pairs using both the language model and the expert models until a predetermined threshold number of executions of the language model is reached. Operation 650 may further include, when the number of executions exceeds the threshold, generating a key-value pair of the key-value pairs using the language model, without using the expert models.

The first key may represent a high level class of an object in the input data, and the first expert model may serve as a high level classifier. The second key may represent a low level class within the high level class, and the second expert model may serve as a low level classifier.

Referring to FIG. 7, in operation 710, the electronic device may generate early key-value pairs of output data by alternately executing a language model and expert models until the number of executions of the language model reaches a predetermined threshold. In operation 720, in response to the threshold being exceeded, the electronic device generates late key-value pairs of output data by executing only the language model, without invoking the expert models.

Operation 710 may further include executing the language model based on the input data to generate a first key of the early key-value pairs, executing a first expert model based on the first key to generate a first value of the first key, executing the language model again based on the first key and the first value to generate a second key, and executing a second expert model based on the second key to generate a second value of the second key.

The generating of the first value in operation 710 may include selecting the first expert model with the highest suitability for processing the first key, from among the expert models, and executing the first expert model based on the input data to generate the first value. The selecting of the first expert model may include selecting the first expert model matched to the first key among the expert models matched to a plurality of keys. The selecting of the first expert model may include executing a selection model based on the first key to generate suitability scores indicating a suitability of the expert models for processing the first key, and selecting the first expert model among the expert models based on the suitability scores.

The generating of the first value may include generating the first value using the language model in place of the expert models when the language model has a higher suitability than the expert models for processing the first key.

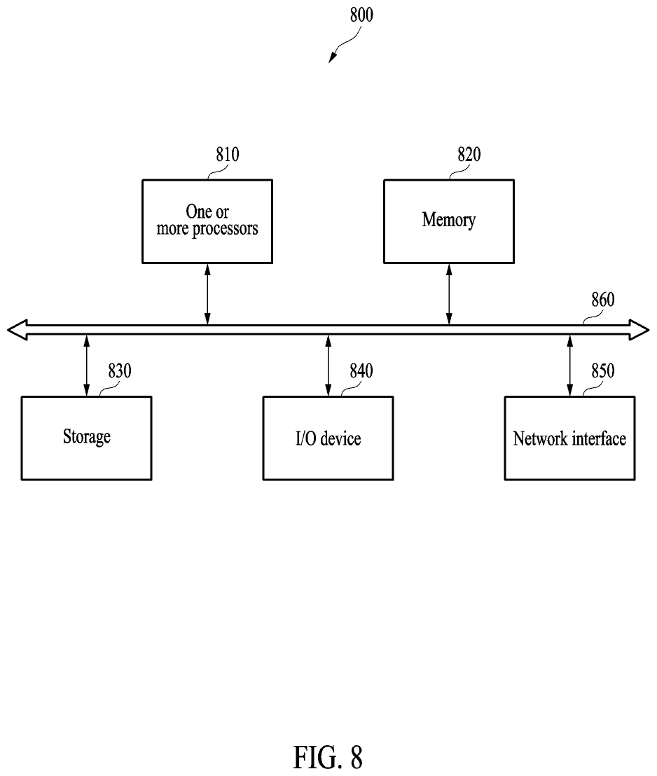

FIG. 8 illustrates an example configuration of an electronic device according to one or more embodiments. Referring to FIG. 8, an electronic device 800 may include one or more processors 810, memory 820, storage 830, an input/output (I/O) device 840, and a network interface 850, which may be interconnected via a communication bus 860. For example, the electronic device 800 may be implemented, or form part of, as a mobile device (e.g., smartphone, personal digital assistant (PDA), netbook, tablet, and/or laptop), a wearable device (e.g., smartwatch, smart band, or smart glasses), a computing device (e.g., desktop or server), a home appliance (e.g., smart television or refrigerator), a security device (e.g., smart door lock), or a vehicle (e.g., autonomous or smart vehicle).

The one or more processors 810 may execute instructions or code stored in the memory 820 or storage 830. The instructions/code, when executed by the one or more processors 810, may cause the electronic device 800 to perform one or more of the operations described with reference to FIGS. 1 through 7. The memory 820 may include a non-transitory computer-readable storage medium to store instructions/code and temporary runtime data. The memory 820 may store instructions for execution by the one or more processors 810 and may store related information while software and/or applications are executed by the electronic device 800.

The storage 830 may include a non-volatile computer-readable storage medium capable of storing a greater volume of data over a longer duration compared to memory 820. For example, the storage 830 may include a magnetic hard disk, an optical disk, a flash memory, a floppy disk, or other forms of non-volatile memory known in the art.

The I/O device 840 may include devices for receiving user input, such as a keyboard, mouse, touchscreen, microphone, and/or image sensor. The I/O device 840 may be capable of detecting the user input and delivering the detected input to the electronic device 800. The I/O device 840 may also include output devices for conveying visual, auditory, or tactile information to the user, such as a display, speaker, and/or vibration-generating device. The network interface 850 may enable communication with external systems via wired or wireless networking technologies.

The electronic devices, processors, memories, storage devices, interfaces, I/O devices, controllers, electronic device 800, processors 810, memory 820, storage 830, I/O device 840, network interface 850, communication bus 860, and other apparatuses, devices, models, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method, the method comprising:
executing a language model based on non-text-based input data to generate a first key for describing the input data in a text-based key-value format;
executing a first expert model, selected from among expert models, based on the first key to generate a first value corresponding to the first key;
executing the language model based on the first key and the first value to generate a second key;
executing a second expert model, selected from among the expert models, based on the second key to generate a second value corresponding to the second key; and
generating output data in the text-based key-value format by executing the language model and the expert models based on a first key-value pair comprising the first key and the first value, and a second key-value pair comprising the second key and the second value.

2. The method of claim 1, wherein the generating of the first value comprises:
selecting the first expert model having a highest suitability for processing the first key from among the expert models; and
executing the selected first expert model based on the input data to generate the first value.

3. The method of claim 2, wherein the selecting of the first expert model comprises selecting the first expert model matched to the first key from among the expert models matched to a plurality of keys.

4. The method of claim 2, wherein the selecting of the first expert model comprises:
executing a selection model based on the first key to generate suitability scores indicating a suitability of each of the expert models for processing the first key; and
selecting the first expert model based on the suitability scores.

5. The method of claim 1, wherein the generating of the first value comprises, in response to a determination that the language model has a higher suitability than the expert models for processing the first key, generating the first value using the language model in place of the expert models.

6. The method of claim 1, wherein the generating of the output data comprises:
generating one or more key-value pairs using the language model and the expert models until a number of executions of the language model reaches a threshold; and
generating one or more additional key-value pairs using the language model without the expert models in response to the number of executions of the language model exceeding the threshold.

7. The method of claim 1, wherein the first key represents a high level class of an object in the input data, and the first expert model serves as a high level classifier.

8. The method of claim 7, wherein the second key represents a low level class within the high level class, and the second expert model serves as a low level classifier.

9. A method of describing non-text-based input data in a text-based key-value format, the method comprising:
generating early key-value pairs of output data by alternately executing a language model and expert models until a number of executions of the language model reaches a threshold; and
generating late key-value pairs of output data, subsequent to the early key-value pairs, by executing the language model without the expert models in response to the number of executions of the language model exceeding the threshold.

10. The method of claim 9, wherein the generating of the early key-value pairs comprises:
executing the language model based on the input data to generate a first key of the early key-value pairs;
executing a first expert model, selected from among the expert models, based on the first key to generate a first value corresponding to the first key;
executing the language model based on the first key and the first value to generate a second key; and
executing a second expert model, selected from among the expert models, based on the second key to generate a second value corresponding to the second key.

11. The method of claim 10, wherein the generating of the first value comprises:
selecting the first expert model having a highest suitability for processing the first key from among the expert models; and
executing the first expert model based on the input data to generate the first value.

12. The method of claim 11, wherein the selecting of the first expert model comprises selecting the first expert model matched to the first key from among the expert models matched to a plurality of keys.

13. The method of claim 11, wherein the selecting of the first expert model comprises:
executing a selection model based on the first key to generate suitability scores indicating a suitability of each of the expert models for processing the first key; and
selecting the first expert model based on the suitability scores.

14. The method of claim 10, wherein the generating of the first value comprises, in response to a determination that the language model has a higher suitability than the expert models for processing the first key, generating the first value using the language model in place of the expert models.

15. An electronic device, comprising:
one or more processors; and
a memory storing code,
wherein the code, when executed by the one or more processors, configures the one or more processors to,
execute a language model based on non-text-based input data to generate a first key for describing the input data in a text-based key-value format,
execute a first expert model, selected from among expert models, based on the first key to generate a first value corresponding to the first key,
execute the language model based on the first key and the first value to generate a second key,
execute a second expert model, selected from among the expert models, based on the second key to generate a second value corresponding to the second key, and
generate output data in the text-based key-value format by executing the language model and the expert models based on a first key-value pair comprising the first key and the first value, and a second key-value pair comprising the second key and the second value.

16. The electronic device of claim 15, wherein the one or more processors are further configured to:
select the first expert model having a highest suitability for processing the first key from among the expert models; and
execute the first expert model based on the input data to generate the first value.

17. The electronic device of claim 16, wherein the one or more processors are further configured to:
select the first expert model matched to the first key from among the expert models matched to a plurality of keys.

18. The electronic device of claim 16, wherein the one or more processors are further configured to:
execute a selection model based on the first key to generate suitability scores for the expert models, and
select the first expert model based on the suitability scores.

19. The electronic device of claim 15, wherein the one or more processors are further configured to:
in response to the language model having a higher suitability than the expert models for processing the first key, generate the first value using the language model in place of the expert models.

20. The electronic device of claim 15, wherein the one or more processors are further configured to:
generate one or more key-value pairs using the language model and the expert models until a number of executions of the language model reaches a threshold, and
generate one or more additional key-value pairs using the language model without the expert models in response to the number of executions of the language model exceeding the threshold.
